(19) United States
(12) Patent Application Publication
(10) Pub. No.: US 2003/0230610 A1
(43) Pub. Date: Dec. 18, 2003

(54) Tidy Trunk

(76) Inventors: Anita Louise Cyr-Hasty, South Lake Tahoe, CA (US); Dersa Rose Cyr, South Lake Tahoe, CA (US)

Correspondence Address: Anita L. Cyr-Hasty, 2539 Fountain Ave., South Lake Tahoe, CA, 96150, US

(21) Appl. No.: 10/105,970

(22) Filed: Jun. 17, 2002

(51) Int. Cl. B60R 9/00; B60R 11/00; B60R 7/00

(52) U.S. Cl. 224/497; 224/542; 224/925

(57) ABSTRACT

A virtual market making system to allow for demand based pricing of drugs to be utilized by pharmaceutical manufacturers, payors, prescribers, electronic service providers, pharmacy benefit management companies, and other parties involved in the exchange of drugs and their relevant pricing and identification information. The market making system includes the calculation and presentation of the drug pricing information, the drug identification information, as well as the exchange of monies between participating entities in the market making system. In addition, the system allows for informational exchange between the participating entities in order to gauge market demand and adjust price accordingly. The system has the ability to interact with remote and directly connected electronic devices, databases, and information providers. The system also has the ability to interact with online and offline drug information, participating entities, and servicers.

### SPECIFICATIONS

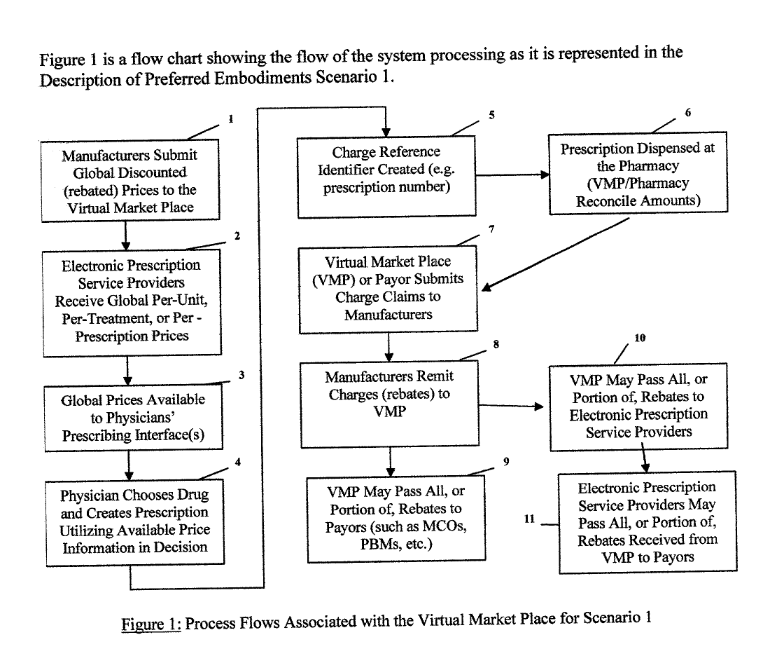

This invention is designed primarily as an enclosure system to secure grocery or other bags for transportation in a vehicle from the store to the home. It will secure and enable the contents to remain safely and conveniently in the bags throughout the driving period. (See FIG. 1) This invention can also be used to hold and store other items such as emergency equipment, tools, etc. in the back of a trunk, vehicle storage area or truck in an orderly manner for an indefinite time period.

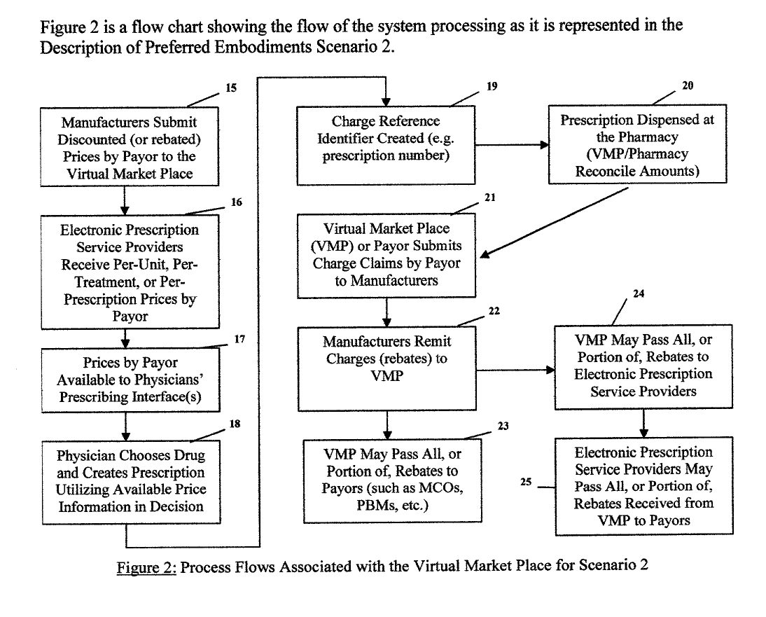

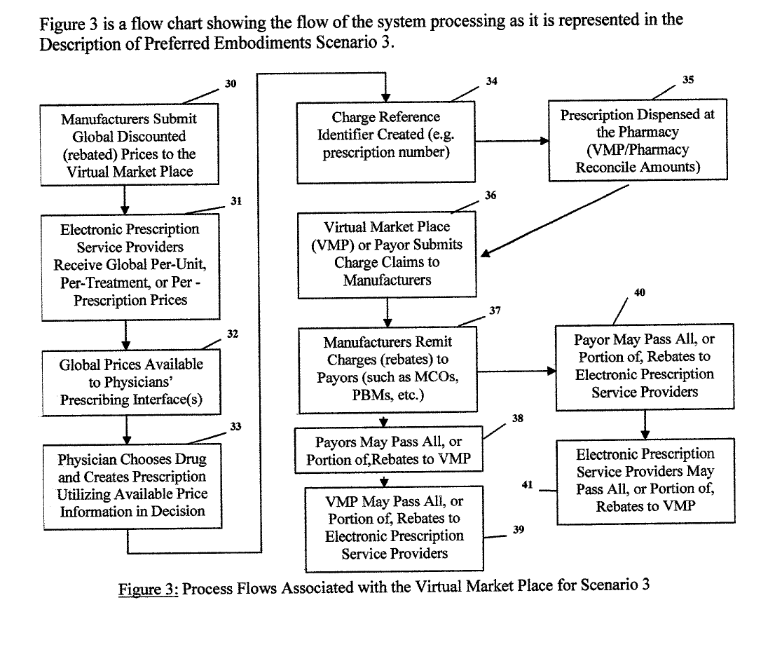

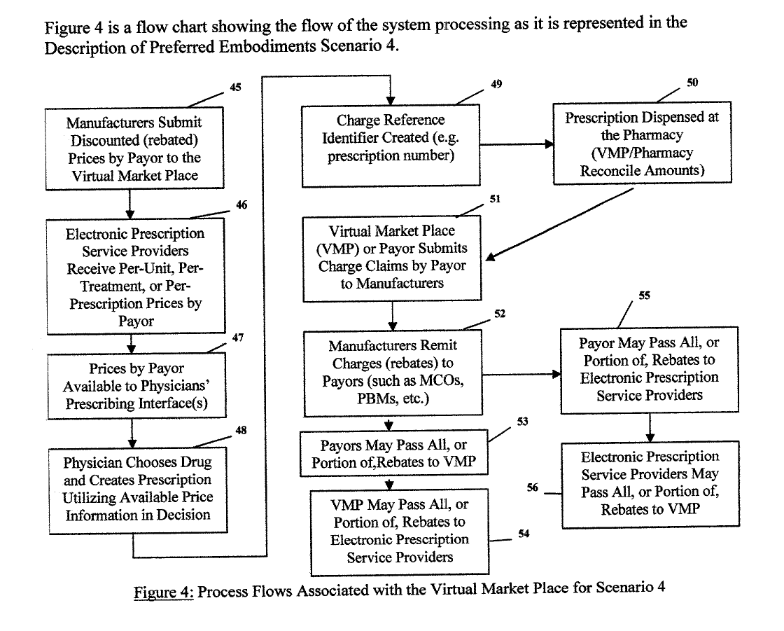

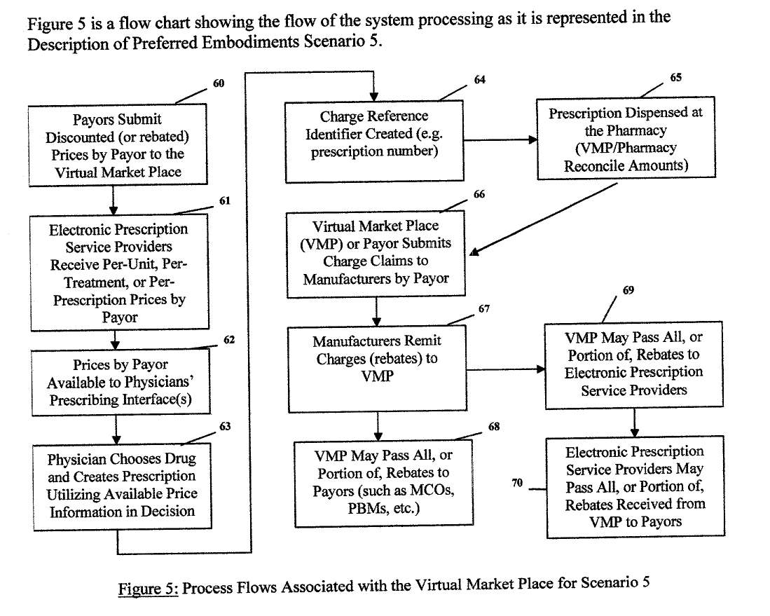

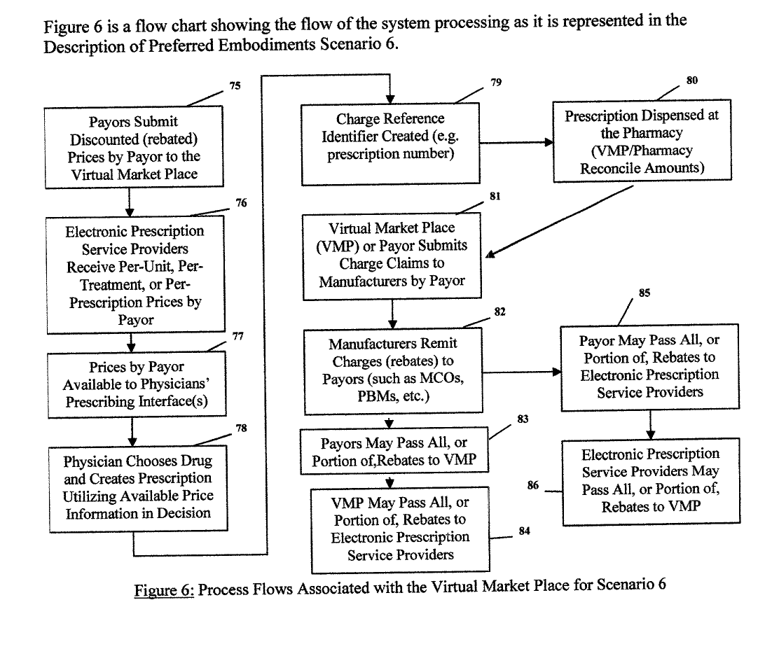

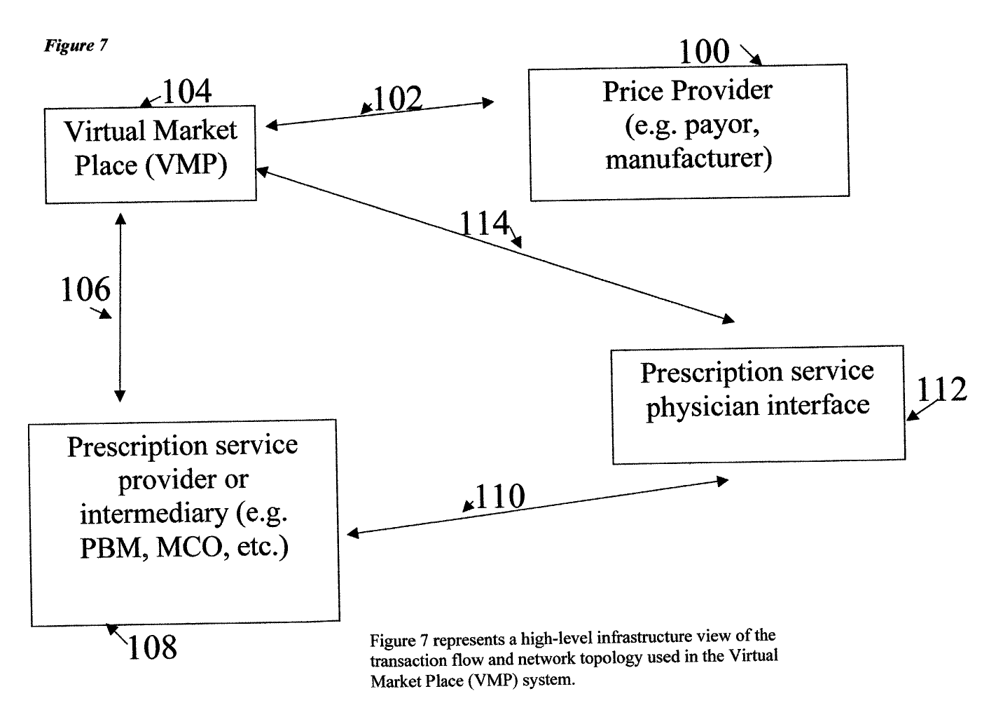

It is designed to be put together quickly and easily, consisting of 2 top slotted base pieces, and 3 bottom slotted cross pieces, (See FIGS. 2a & 2b) that slide together as shown (See FIGS. 3,4&5). To enclose all twelve compartments there is a frame, consisting of 4 alternately slotted frame pieces, that fit conveniently over the entire structure for complete enclosure. (See FIGS. 6&7) Invention can be used with or without frame at users discretion.

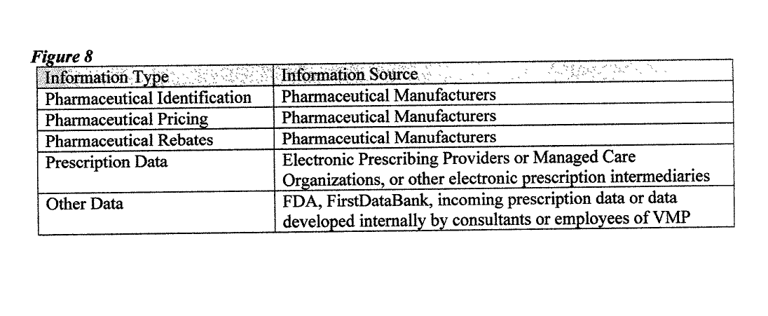

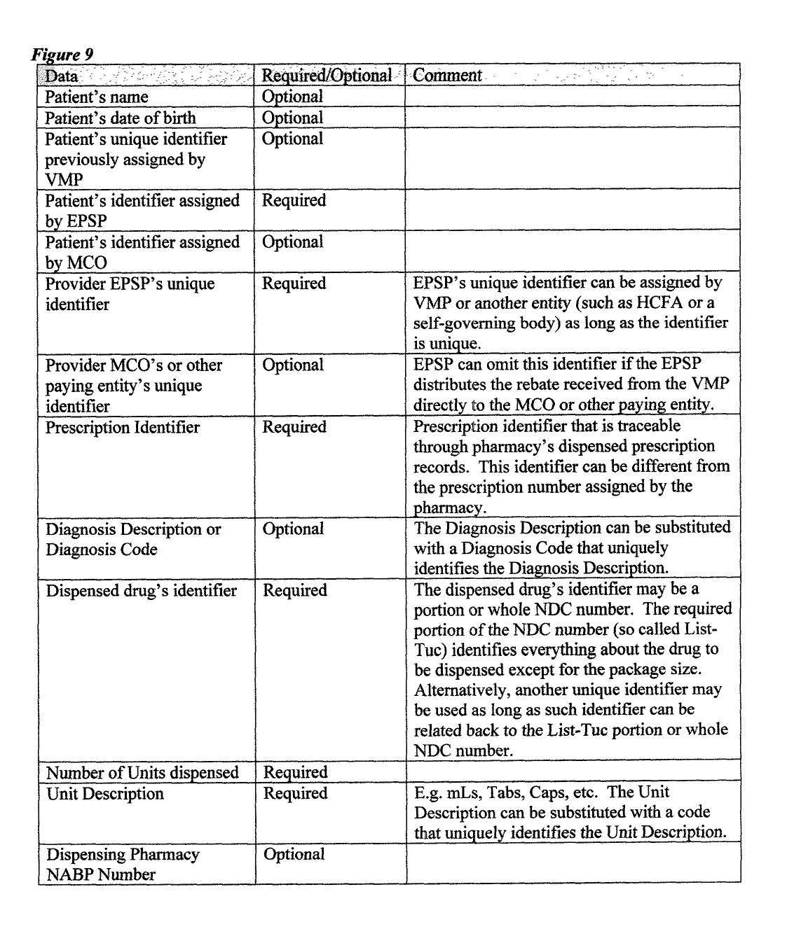

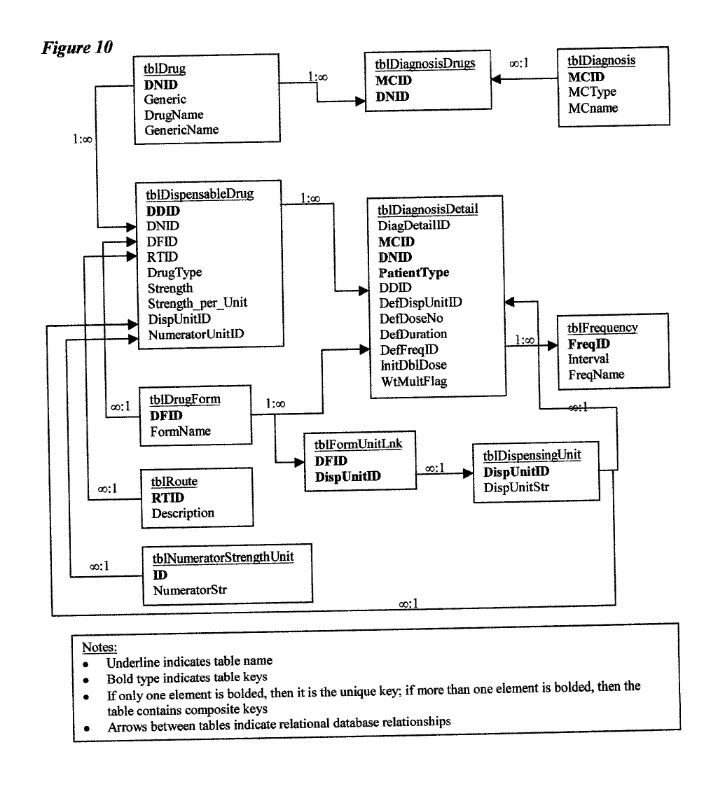

This invention is also designed to fit together in a variety of pocket patterns to accommodate a wide variety of product sizes and shapes and facilitate other storage uses. This is done by the simple removal of one or more of the cross, or base pieces as shown (See FIGS. 8,9&10) but are not limited to the variations shown.

The easy hold tabs located on all base and cross pieces (See FIG. 2c) and easy hold slots located on all frame pieces (See FIG. 6a) are an extra design feature that helps prevent movement of the pockets and frame and provide extra strength. Tabs, on base and cross pieces, slip easily into slots, on and around frame pieces. (See FIGS. 1&7)

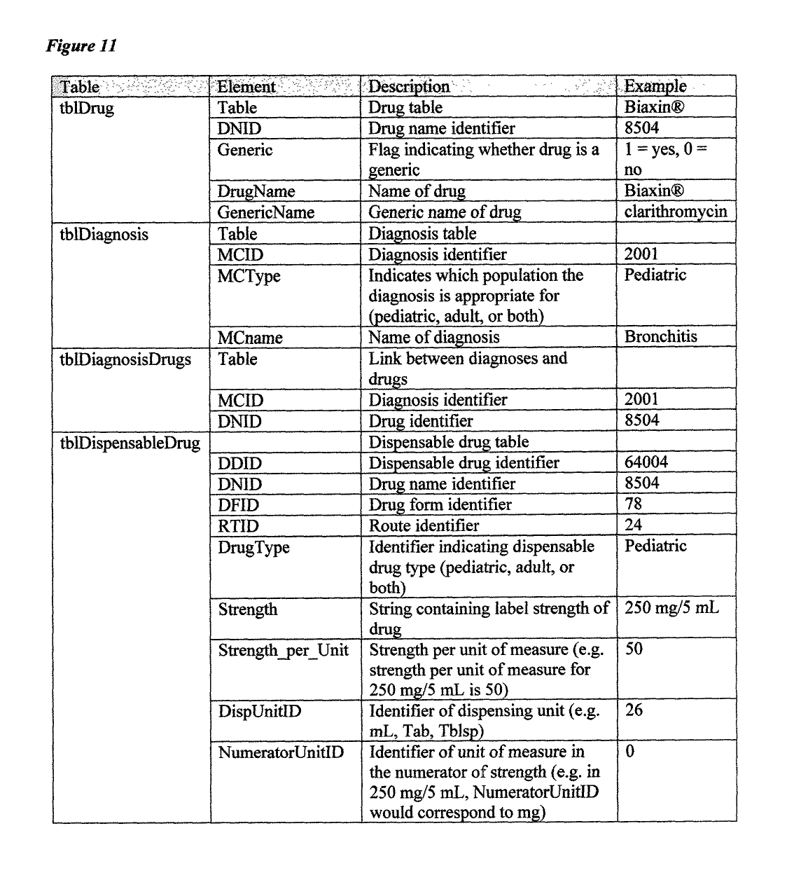

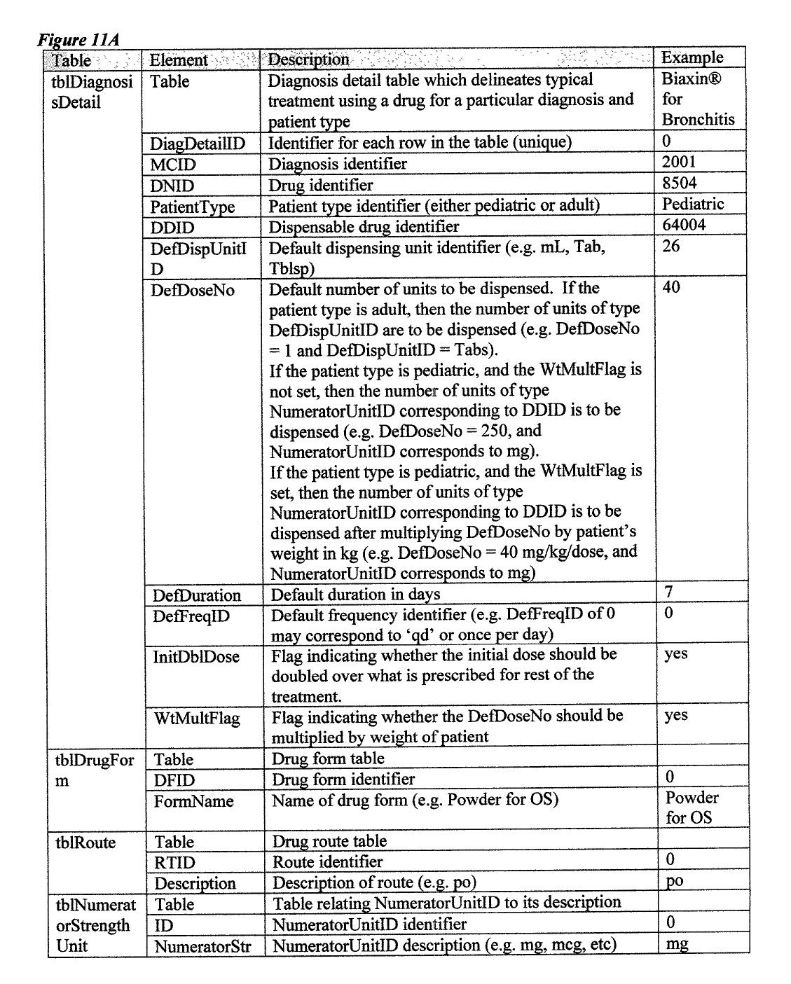

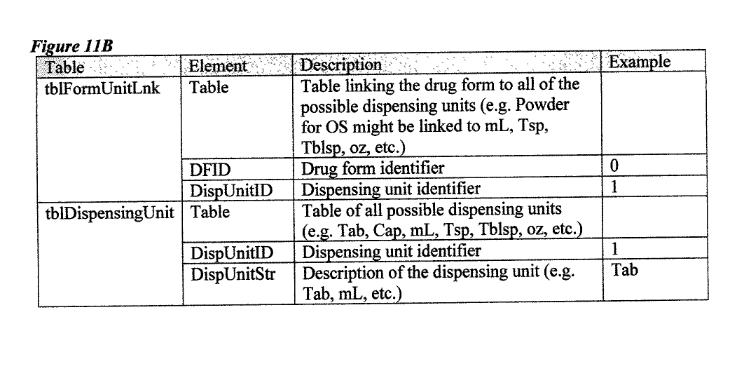

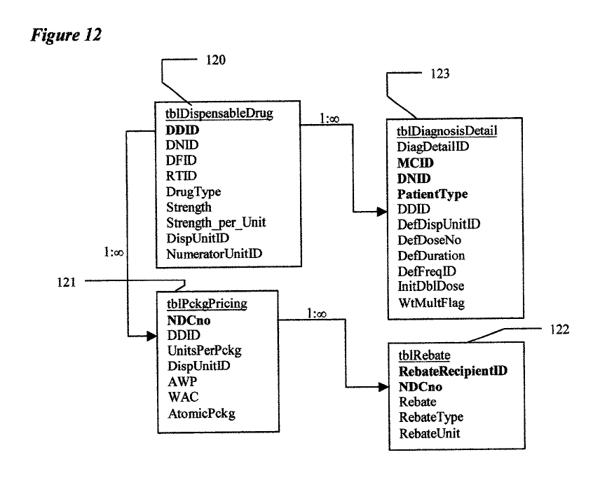

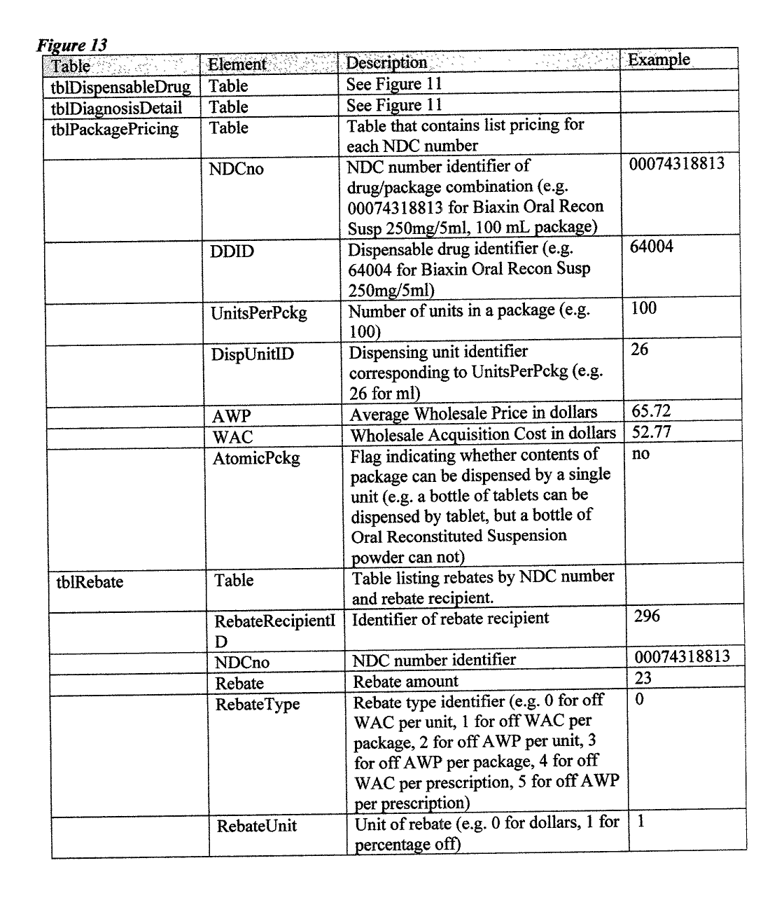

When not in use, this invention is designed to easily compress and fold flat, without disassembling for storage in trunk or area of storage in cars not designed with trunks, or back of truck, to provide full use of trunk space or truck bed. (See FIG. 11) It is designed to pop up again for easy and immediate use.

While the standard size dimensions are approximate, this invention might be designed in various sizes to accommodate all sized vehicles. Approximate standard size dimensions are 42 in.×34½ in. and can be used in either direction. Approximate pocket size is 11 in.×10½ in. Approximate pocket depth is 8 in. Actual dimensions will be decided during the manufacturing process.

It is our intention to produce this invention out of a strong, flexible material such as corrugated cardboard, plastic, etc. but not limited to those materials. Actual product material will also be determined during the manufacturing process.

Our invention, although pictured in black and white, may be manufactured in various solid or printed colors at our discretion at the time of manufacturing.

### Tidy Trunk

### BRIEF DESCRIPTION OF THE SEVERAL VIEWS OF THE DRAWINGS

Enclosure system to secure grocery, other bags or individual items safely and conveniently during transportation from one destination to another. (See FIG. 1)

Two top slotted base pieces, and three bottom slotted cross pieces, (See FIGS. 2a&2b) that slide together. (See FIGS. 3,4&5)

Frame, consisting of four alternately slotted frame pieces that fir conveniently over entire structure for complete enclosure. (See FIGS. 6&7)

Modification by the simple removal of one or more of the cross or base pieces. (See FIG. 8.9&10)

“Easy Hold” tabs located on base and cross pieces. (See FIG. 2c)

“Easy Hold” slots located on frame pieces. (See FIG. 6a)

Tabs on base and cross pieces slip easily into Slots on and around frame pieces. (See FIGS. 1&7)

Compresses and folds flat, without disassembling. (See FIG. 11)

We claim:

1. A method for providing pharmaceutical information in a virtual marketplace, comprising:
receiving pricing information for at least one drug;
computing a per course of treatment price for at least one drug; and
responsively providing the per course of treatment price for at least one drug to a requestor.

2. The method of claim 1, wherein receiving pricing information comprises:
receiving pricing information for at least one drug from a pharmaceutical manufacturer; and
receiving rebate information for at least one drug from the pharmaceutical manufacturer.

3. The method of claim 1, wherein computing a per course of treatment price comprises:
obtaining a unit price for at least one drug;
obtaining rebate information for at least one drug; and
determining treatment information, wherein the treatment information indicates a condition that can be treated using at least one drug, and wherein the treatment information indicates a number of drug units used to treat the condition.

4. The method of claim 1, wherein at least one drug comprises a plurality of drugs, wherein each of the plurality of drugs has associated with it at least one condition that can be treated using the drug, the method further comprising:
receiving an indication of a condition;
determining which of the plurality of drugs are associated with the condition; and
sending the per course of treatment price for each of the plurality of drugs associated with the condition.

5. The method of claim 4, further comprising:
receiving an electronic prescription, wherein the electronic prescription indicates one of the plurality of drugs associated with the condition;
determining a rebate to be received from a pharmaceutical manufacturer for the electronic prescription; and
notifying the pharmaceutical manufacturer of the rebate.

6. The method of claim 5, further comprising:
confirming a fulfillment of the electronic prescription; and
receiving a rebate from the pharmaceutical manufacturer.

7. The method of claim 5, further comprising:
confirming a fulfillment of the electronic prescription; and
notifying the pharmaceutical manufacturer of a payor to which the rebate should be paid.

8. The method of claim 4, wherein sending the per course of treatment price for each of the plurality of drugs associated with the condition further comprises sending the per course of treatment prices for each of the plurality of drugs associated with the condition to an electronic device.

9. The method of claim 8, wherein the electronic device is a personal digital assistant, a computer or a mobile phone.

10. The method of claim 4, wherein sending the course of treatment price for each of the plurality of drugs associated with the condition further comprises sending the per course of treatment prices for each of the plurality of drugs associated with the condition to an electronic prescription service.

11. A method for providing drug pricing information, the method comprising:
receiving from a pharmaceutical manufacturer pricing information for a plurality of drugs, wherein the pricing information for each of the plurality of drugs has associated with it at least one payor;
receiving from the pharmaceutical manufacturer rebate information for the plurality of drugs; and
generating at least one per course of treatment price for each of the plurality of drugs, wherein at least one per course of treatment price for each of the plurality of drugs has associated with it a payor.

12. The method of claim 1, further comprising:
receiving an indication of a diagnosis of a condition;
determining which of the plurality of drugs may be used to treat the condition; and
providing at least one per course of treatment price for each of the plurality of drugs that may be used to treat the condition.

13. The method of claim 12, further comprising:
receiving an indication of a prescription for a prescribed drug, wherein the prescribed drug is one of the plurality of drugs that may be used to treat the condition; and
notifying a manufacturer of the prescribed drug of the prescription.

14. The method of claim 13, further comprising:
confirming a purchase of the prescribed drug; and
receiving a rebate from the manufacturer of the prescribed drug.

15. The method of claim 11, wherein the payor is a health maintenance organization, a self-insured employer, a pharmacy benefit management (PBM) company, an electronic service provider, an individual, a state government entity, or a federal government entity.

16. A method for ordering drugs from a virtual marketplace, comprising:
entering a diagnosis for a condition;
sending an indication of the condition to the virtual marketplace; and
receiving a list of drugs, wherein each drug in the list can be used to treat the condition, and wherein the list includes a per course of treatment price for each drug in the list.

17. The method of claim 16, further comprising sending an indication of a drug in the list to the virtual marketplace in order to generate a prescription for the drug.

18. The method of claim 16, wherein each drug in the list has associated with it at least one per course of treatment price corresponding to a payor.

19. The method of claim 16, wherein the at least one per course of treatment price includes a plurality of per course of treatment prices, and wherein each of the plurality of per course of treatment prices has associated with it a different payor.

20. The method of claim 16, wherein sending an indication of the condition to the virtual marketplace uses a wireless device.
